(19) United States
(12) Patent Application Publication
(10) Pub. No.: US 2006/0000560 A1
(43) Pub. Date: Jan. 5, 2006

(54) Apparatus and method for removably attaching window treatments

(76) Inventor: Michael A. Lewis, Akron, OH (US)

Correspondence Address: SAND & SEBOLT, AEGIS TOWER, SUITE 1100, 4940 MUNSON STREET, NW, CANTON, OH, 44718-3615, US

(21) Appl. No.: 11/158,580

(22) Filed: Jun. 22, 2005

Related U.S. Application Data
(60) Provisional application No. 60/585,234, filed on Jul. 2, 2004.

(51) Int. Cl. E06B 9/00

(52) U.S. Cl. 160/38

(57) ABSTRACT

A mounting system for supporting window treatments such as curtains, shades and blinds includes a wall plate for mounting on a generally vertical surface and a bracket mount removably connected to the wall plate. A support on which a hanging rod for the window treatments is suspended is attached to the bracket mount whereby one type of support used with a given type of window treatment may be removed and replaced by another type of support used with another type of window treatment.

### CROSS REFERENCE TO RELATED APPLICATIONS

This application claims priority from U.S. provisional application Ser. No. 60/585,234 filed Jul. 2, 2004; the disclosure of which is incorporated herein by reference.

### BACKGROUND OF THE INVENTION

1. Technical Field

The invention relates to window treatments or window hangings. More particularly, the invention relates to a mounting system by which window treatments are mounted to a wall, a window frame or a similar structure. Specifically, the invention relates to such a mounting system having removable bracket mounts by which one type of window treatment may be easily removed and replaced by another type of window treatment.

2. Background Information

As is well known, there are a variety of window treatments or window hangings which are typically used to cover all or some portion of a window opening. Such treatments are commonly used to block out light and heat, for decorative reasons, or both. Window treatments include a great variety of curtains, blinds and shades. Along with this great variety come a host of mounting systems which typically include a pair of supports each of which is typically mounted to a wall with one or more fasteners, commonly screws.

A problem arises when the window treatment is to replaced by another window treatment which uses a different support in its mounting system. When this occurs, then either the old support remains mounted on the wall along with the new one typically nearby or the old support is removed before the new support is installed. In the former case, the old support may be visible and be contrary to aesthetic appeal. In the latter case, the additional effort of removing the old support is required and the filling of holes and repainting may also be involved. The aesthetic concern arises again if the holes are visible and not filled and/or not painted over. In addition, if the new support must be mounted in virtually the same location as the old support, the holes from the old support may need to be appropriately filled in order to provide a suitable foundation for mounting the new support, a task that is often not easily achieved.

The present invention solves the above problems with a mounting system by which the varied supports for any number of window treatments may be removably mounted to a wall or other structure to allow easy removal and replacement of differing types of window treatments.

### BRIEF SUMMARY OF THE INVENTION

The present invention provides a mounting system for supporting a window treatment, the system comprising a first mounting member adapted to be mounted on a generally vertical surface; and a second mounting member removably mounted on the first mounting member and adapted to connect to a window treatment support.

The present invention further provides a method comprising the steps of mounting first and second window treatment supports removably and respectively on first and second wall members which are mounted on a generally vertical surface and spaced from one another; and installing a first window treatment on the first and second supports.

### BRIEF DESCRIPTION OF THE SEVERAL VIEWS OF THE DRAWINGS

FIG. 1 is an elevational view of the mounting system of the present invention in use with window blinds.

FIG. 2 is a fragmentary perspective view of the wall plate of the mounting system of FIG. 1 in the process of being mounted on a wall.

FIG. 3 is similar to FIG. 2 and shows the wall plate mounted on the wall and a first embodiment of a mounting bracket with first and second bracket mounts connected thereto prior to mounting the mounting bracket on the wall plate via one of the bracket mounts.

FIG. 4 is a side elevational view of the mounting bracket showing the second bracket mount connected thereto.

FIG. 5 is a side elevational view of the mounting bracket from the opposite side as shown in FIG. 4 showing the first and second bracket mounts connected thereto.

FIG. 6 is a front elevational view of the mounting bracket showing the first bracket mount connected thereto.

FIG. 7 is a rear elevational view of the mounting bracket showing the first and second bracket mounts connected thereto.

FIG. 8 is similar to FIG. 3 and shows the mounting bracket mounted on the wall plate via the first bracket mount.

FIG. 9 is a sectional view taken on line 9-9 of FIG. 8.

FIG. 10 is a sectional view taken on line 10-10 of FIG. 9.

FIG. 11 is a second embodiment of a mounting bracket connected to a bracket mount.

FIG. 12 is a third embodiment of a mounting bracket connected to a bracket mount.

FIG. 13 is a fourth embodiment of a mounting bracket connected to a bracket mount.

FIG. 14 is a fifth embodiment of a mounting bracket connected to a bracket mount.

FIG. 15 is a sixth embodiment of a mounting bracket connected to a bracket mount.

Similar numerals refer to similar parts throughout the drawings.

### DETAILED DESCRIPTION OF THE INVENTION

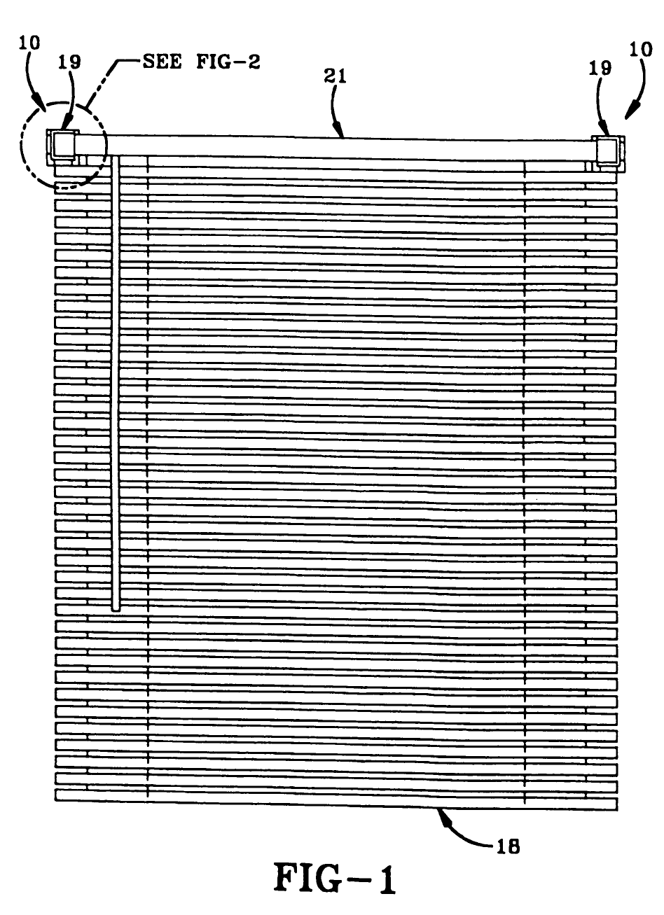

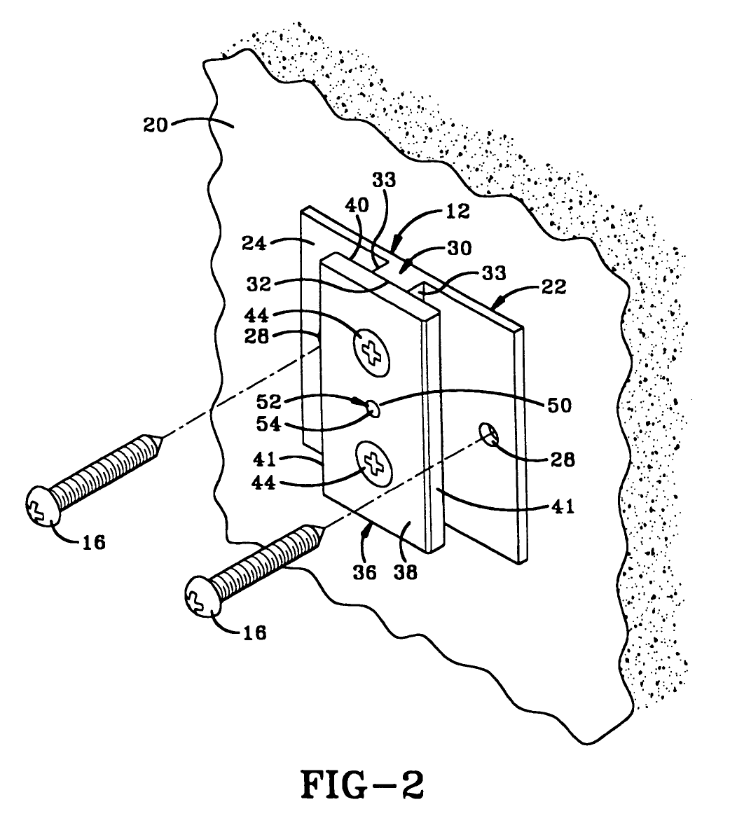

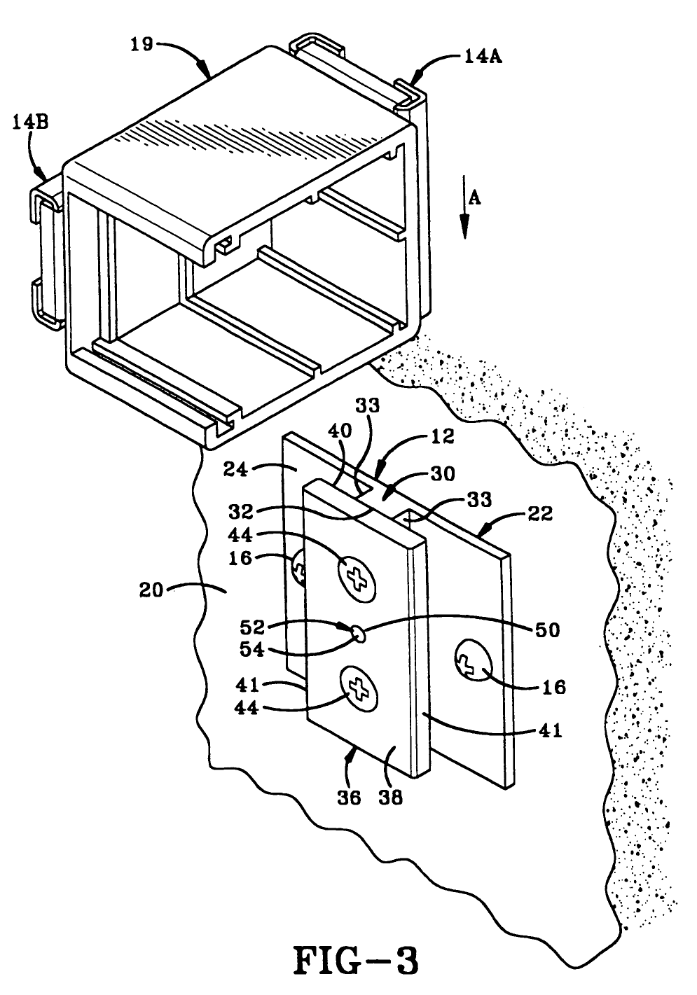

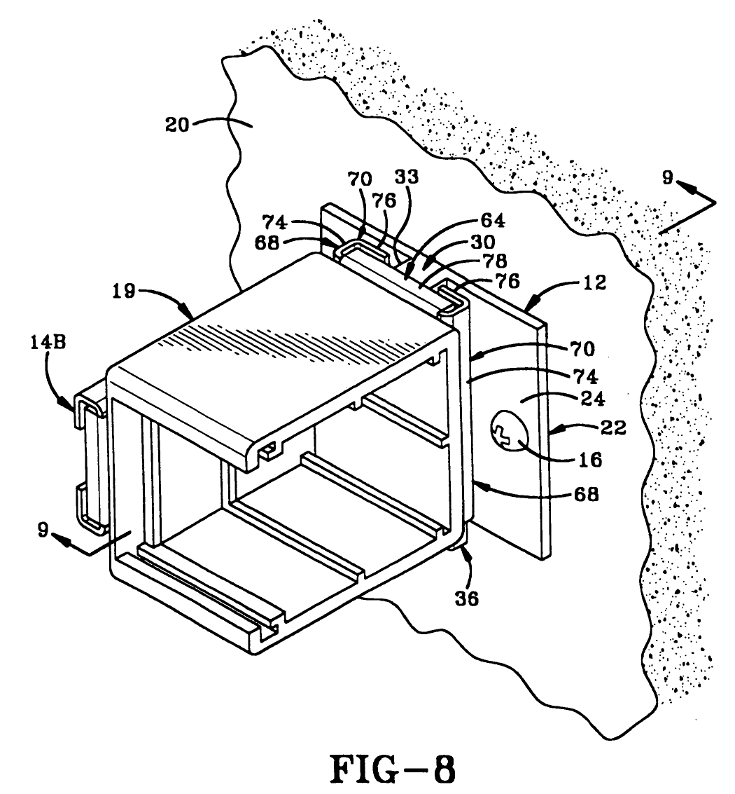

The mounting system of the present invention is indicated generally at 10 and shown in FIGS. 1 and 8-10. Mounting system 10 includes a first mounting member or wall plate 12 (FIGS. 2-3) and a second mounting member or bracket mount 14A (FIGS. 3-7 and 11-15) removably mounted to wall plate 12. System 10 further includes fasteners in the form of screws 16 (FIG. 2). Mounting system 10 is configured to mount a window treatment in the form of blinds 18 via a hanging member 21 (FIG. 1) on a wall 20 (FIG. 2) or other generally vertical surface, which is often the inside of a window frame or wall adjacent a window frame. Bracket mount 14A is adapted to attach to one of a pair of supports 19 from which blinds 18 are suspended.

More particularly and in accordance with a main feature of the invention, system 10 is configured to allow one type of window treatment to be easily removed and replaced by another type of window treatment. System 10 may include an additional bracket mount 14B (FIG. 3) which has the same configuration as bracket mount 14A except for being longer than bracket mount 14A, in keeping with the different dimensions of the respective sides on which the bracket mounts are attached to support 19. Bracket mounts 14A and 14B may also be the same length and so are treated as having the same configuration for present purposes. Bracket mounts 14A and 14B are adapted to attach to the same support 19 whereby, via alternate use of bracket mounts 14A and 14B, support 19 may be disposed in alternate orientations for suspending alternate window treatments having different hanging members or rods respectively suited to work with support 19 in the alternate orientations.

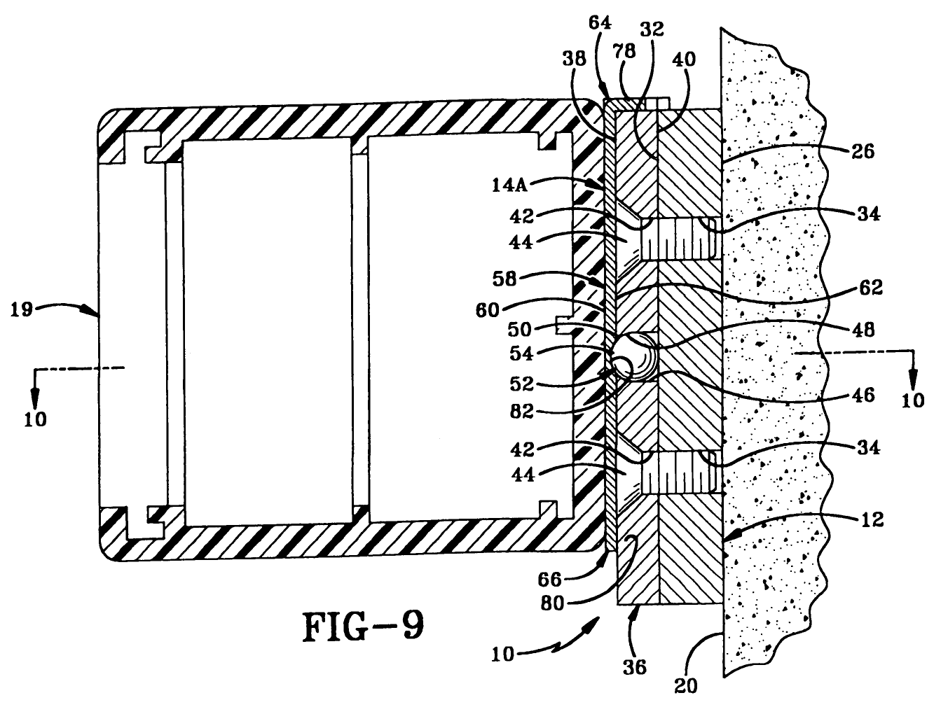

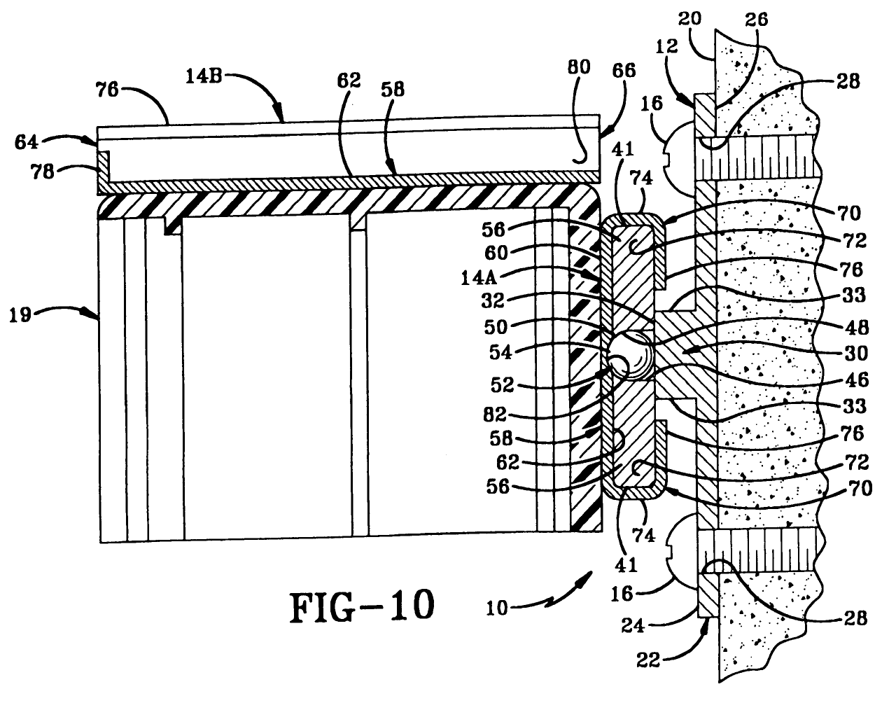

Wall plate 12 (FIGS. 2, 9 and 10) includes a substantially flat base plate 22 having a pair of opposed substantially flat surfaces 24 and 26 (FIGS. 9-10) and defining a pair of spaced holes 28 each extending from surface 24 to surface 26. Base plate 22 is configured to mount to wall 20 with screws 16 via respective holes 28. Wall plate 12 also includes an elongated neck 30 extending outwardly from surface 24 of base plate 22. Base plate 22 and neck 30 are formed as an integral one-piece member. Neck 30 has an attaching side 32 (FIG. 10) facing away from base plate 22. Neck 30 has a pair of opposed sides 33 extending outwardly from surface 24 of base plate 22 to attaching side 32 of neck 30, sides 33 being perpendicular to each of surface 24 and attaching side 32. Neck 30 defines a pair of spaced threaded holes 34 (FIG. 9) each extending from attaching side 32 and into and through base plate 22 to surface 26 thereof.

Wall plate 12 further includes a flat connector plate 36 having a pair of opposed substantially flat surfaces 38 and 40. Surface 38 faces away from base plate 22 and surface 40 faces base plate 22. Surfaces 38 and 40 of neck 30 are substantially parallel to surfaces 24 and 26 of base plate 22. Connector plate 36 further includes a pair of opposed edges 41 extending substantially perpendicularly to and between surfaces 38 and 40. Connector plate 36 defines a pair of spaced through holes 42 (FIG. 9) each extending from surface 38 to surface 40 thereof. Holes 42 receive a respective pair of screws 44 which threadedly engage holes 34 of neck 30 and base plate 22 to fasten connector plate 36 to neck 30 with surface 40 of connector plate 36 flush against attaching side 32 of neck 30. Connector plate 36 further defines a central through hole 46 (FIGS. 9-10) having a narrowed portion 48 bound by an inwardly extending annular flange 50 of connector plate 36. Hole 46 receives a ball 52 to form a detent. Flange 50 creates an interference with ball 52 to prevent ball 52 from exiting hole 46 toward surface 38 of connector plate 36. Side 32 of neck 30 holds ball 52 in place opposite flange 50 and positions ball 52 so that a portion 54 thereof extends outwardly beyond surface 38 of connector plate 36. When connected to neck 30, connector plate 36 forms a pair of extensions or wings 56 (FIG. 10) which extend laterally beyond respective sides 33 of neck 30 in a direction substantially perpendicular to sides 33. Stated another way, connector plate is wider between edges 41 than is neck 30 between sides 33, and each edge 41 is disposed laterally outwardly from a respective side 33 of neck 30.

Bracket mount 14A (FIGS. 3-7 and 11-15) is now described. As previously noted, bracket mounts 14A and 14B are treated as having the same configuration although they are depicted as having different lengths. Each of bracket mounts 14A and 14B is attached to support 19 via any suitable fastening means, which is typically glue or an adhesive, although Velcro or other options known in the art may be used. By way of further example, where bracket mount 14A and support 19 are both made of metal, they may be joined, for instance, by welding, and where they are both made of plastic, they may be joined, for instance, by sonic welding.

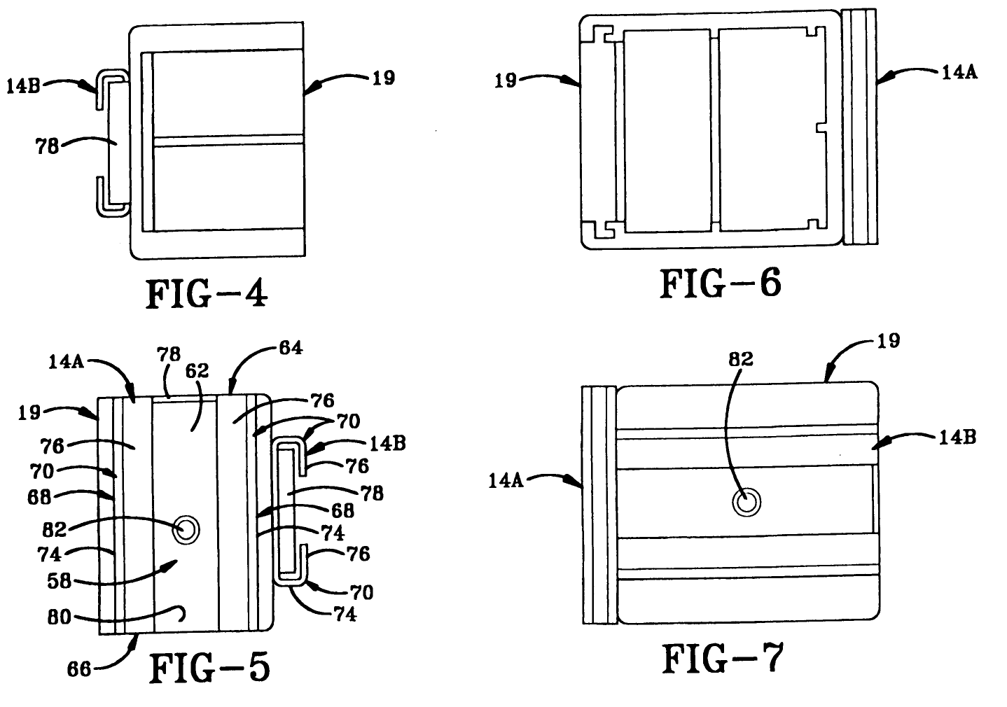

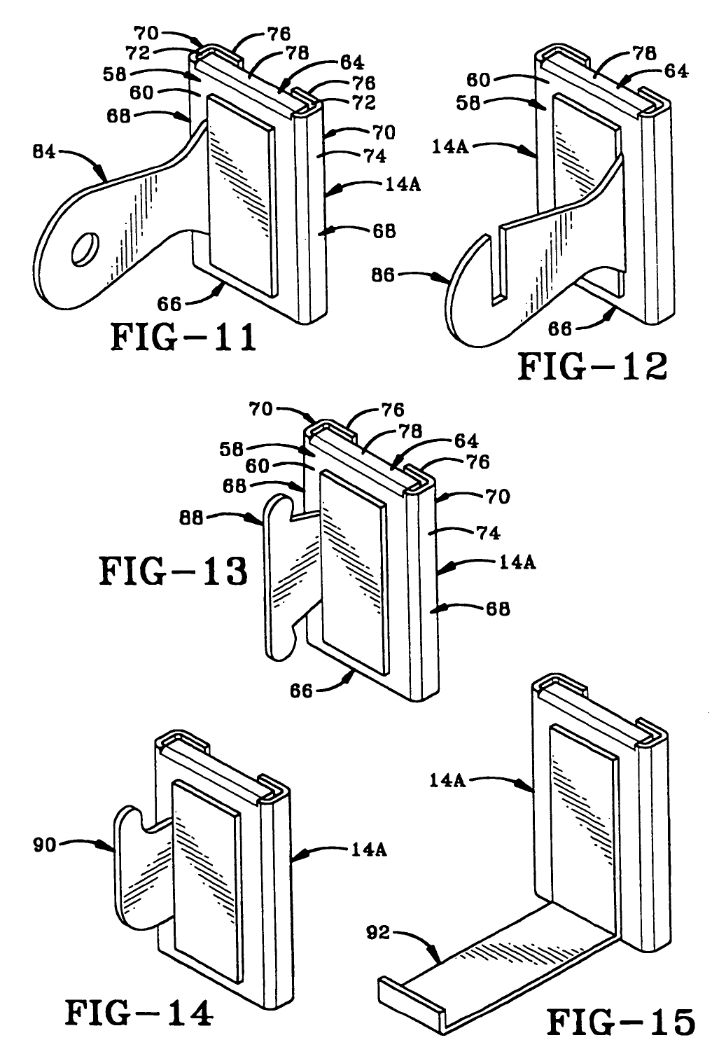

Bracket mount 14A (FIGS. 5 and 11) includes a substantially flat support-connecting plate 58 having a substantially flat outer surface 60 (FIG. 11) and a substantially flat inner surface 62 (FIG. 5) in opposed relation to surface 60. Plate 58 has an upper end 64, a lower end 66 and a pair of opposed sides 68 each extending from upper end 64 to lower end 66. Bracket mount 14A also includes a pair of opposed lateral hooks 70 each extending from a respective side 68 of plate 58 and generally bending around toward inner surface 62 of plate 58 to form an interior space 72 (FIGS. 10-11) between hook 70 and inner surface 62 of plate 58. More particularly, each hook 70 includes a lateral wall 74 which extends substantially perpendicularly from a respective side 68 of plate 58 away from outer surface 60 of plate 58. Each hook 70 further includes a leg 76 extending from lateral wall 74 substantially perpendicularly thereto and substantially parallel to plate 58 whereby each leg 76 extends toward one another. Bracket mount 14A also includes an upper cap or stop 78 extending substantially perpendicularly from plate 58 adjacent upper end 64 away from outer surface 60 of plate 58. Bracket mount 14A defines an entrance opening 80 (FIGS. 5, 9 and 10) adjacent lower end 66 of plate 58 for slidably receiving connector plate 36 of wall plate 12. Plate 58 further defines a depression 82 (FIGS. 5, 9 and 10) extending inwardly from inner surface 62 thereof.

The operation of mounting system 10 is now briefly described (FIGS. 2, 3 and 8-10). A pair of wall plates 12 is mounted on wall 20 via screws 16 via respective holes 28 (FIGS. 2-3). In accordance with a feature of the present invention, bracket mount 14A, with support 19 attached thereto, removably slides onto wall plate 12 in the direction of Arrow A in FIG. 3 whereby connector plate 36 is slidably received via entrance opening 80 of bracket mount 14A to mount bracket mount 14A and support 19 on wall plate 12 (FIG. 3). The sliding of bracket mount 14A and support 19 with respect to wall plate 12 is terminated by an interference between connector plate 36 and stop 78 of bracket mount 14A (FIG. 9). Depression 82 in plate 58 of bracket mount 14A receives portion 54 of ball 52 of wall plate 12, as depression 82 and ball 52 are aligned when connector plate 36 and stop 78 meet. Ball 52 thus provides a detent engaging plate 58 within depression 82 to hinder accidental removal of bracket mount 14A from wall plate 12 while allowing its intentional removal with reasonable ease. Blinds 18 are then installed on supports 19, as is commonly understood. Some supports, such as support 19, may be useful in alternate orientations, as discussed above. Thus, to allow mounting in this alternate orientation, bracket mount 14B may be attached to support 19 and installed on wall plate 12 in the same manner as bracket mount 14A. Clearly, support 19 may have attached thereto either one of bracket mounts 14A and 14B or both of them, the latter scenario allowing either orientation of support 19 and easy interchange between the two orientations.

FIGS. 11-15 show some other examples of supports like support 19 which may be used with bracket 14A. FIGS. 11 and 12 show respectively supports 84 and 86, which are examples of supports commonly used for shades which are attached outside a window frame. FIGS. 13 and 14 show respectively supports 88 and 90, which are examples of supports commonly used to mount curtain rods for hanging curtains. FIG. 15 shows a bottom-support bracket 92 which is often used to support hanging rods for mini-blinds or curtains. A great many other kinds of supports are known in the art which may be easily attached to bracket 14A. As previously noted, some of these supports may fit outside a window frame or within a window frame. It is further noted that mounting system 10 and the variations discussed herein may also be used in any location suitable for hanging such supports and window treatments or other similar structure. Thus, the invention is not limited to use adjacent windows alone or only with window treatments.

A variety of changes, some of which are noted below, may be made to mounting system 10 which are within the scope of the invention. Base plate 22, neck 30, connector plate 36 and ball 52 are typically made of metal. However, a suitable plastic or other suitable material may also be used. Base plate 22, neck 30 and connector plate 36 of wall plate 12 may be a one-piece integral member, which may, for instance, be extruded. This would eliminate the need for screws 44. Alternately, plate 22, neck 30 and plate 36 may be, for example, three separate pieces which are joined together to form a wall plate analogous to wall plate 12. In addition, a variety of shape changes apparent to one skilled in the art may be made without departing from the spirit of the invention.

Flange 50 is annular, but may be of any configuration to retain ball 52 for its purpose as a detent. This type of detent may also be replaced with any other suitable detent known in the art. Further, the detent may be eliminated altogether although it is preferable to have some mechanism to prevent the accidental removal of bracket mount 14A from wall plate 12.

Bracket mount 14A may be removably mounted to wall plate 12 by various means. Instead of a slidable engagement between bracket mount 14A and wall plate 12, a rotational engagement between analogous parts, for instance, may be employed. Other possibilities, for instance, include the use of a removable snap-fit engagement, a hinged connector and so forth. Upper stop 78 may be replaced by a stop in a different location if desired, or eliminated, for instance, by providing a connector plate analogous to plate 36 which has outwardly and downwardly tapered edges analogous to edges 41 and providing a bracket mount like mount 14A having matingly tapered hooks analogous to hooks 70. This configuration would allow such hooks to slidingly receive such a connector plate so that the hooks and connector plate would engage along the connector plate tapered edges so that the tapered hooks would act as a stop to prevent further downward movement of the bracket mount. Other changes within the scope of the invention will be apparent to those skilled in the art.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. A mounting system for supporting a window treatment, the system comprising:
a first mounting member adapted to be mounted on a generally vertical surface; and
a second mounting member removably mounted on the first mounting member and adapted to connect to a window treatment support.

2. The system of claim 1 wherein the second mounting member is slidably mounted on the first mounting member.

3. The system of claim 2 wherein the second mounting member is slidable in a downward direction to mount on the first mounting member.

4. The system of claim 2 further including a detent to help prevent inadvertent removal of the second mounting member from the first mounting member.

5. The system of claim 1 wherein one of the first and second mounting members defines an interior space; and wherein the other of the first and second mounting members includes a connector member which is receivable within the interior space for mounting the second mounting member on the first mounting member.

6. The system of claim 5 wherein the first mounting member includes the connector member and a substantially flat base plate adapted to be mounted on the generally vertical surface; and wherein the connector member is a substantially flat connector plate which is spaced from and substantially parallel to the base plate.

7. The system of claim 6 wherein a neck extends between and is connected to the base plate and the connector plate to space the connector plate from the base plate.

8. The system of claim 5 wherein the second mounting member includes a support-connecting plate adapted for connecting to the support for the window treatment and a pair of opposed lateral hooks extending from the support-connecting plate to form the interior space therebetween.

9. The system of claim 8 wherein the second mounting member includes an upper cap extending from the support-connecting plate to form an upper boundary of the interior space; and wherein the second mounting member defines an entrance opening of the interior space adjacent respective lower ends of the lateral hooks for receiving the connector plate of the first mounting member.

10. The system of claim 1 wherein the second mounting member is removable from the first mounting member solely by movement of the second mounting member in a single linear direction.

11. The system of claim 1 wherein the second mounting member is removable from the first mounting member without removal of any fasteners from the first or second mounting members.

12. The system of claim 1 further including a window treatment support connected to the second mounting member.

13. The system of claim 1 further including a first window treatment support and second window treatment support which is different from the first support; and wherein the first window treatment support is mountable on the second mounting member, removably mounted on the first mounting member via the second mounting member and replaceable by the second window treatment support.

14. The system of claim 1 further including a window treatment support and another second mounting member; wherein the two second mounting members are mounted on the window treatment support so that the support is mountable on the first mounting member in two alternate orientations respectively via alternate mounting of the two second mounting members on the first mounting member.

15. A method comprising the steps of:
mounting first and second window treatment supports removably and respectively on first and second wall members which are mounted on a generally vertical surface and spaced from one another; and
installing a first window treatment on the first and second supports.

16. The method of claim 15 wherein the step of mounting includes the step of moving the supports in a single linear direction.

17. The method of claim 15 further including the steps of removing the first and second supports from the first and second wall members; mounting third and fourth window treatment supports removably and respectively on the first and second wall members; and installing a second window treatment on the third and fourth supports.

18. The method of claim 15 further including the steps of removing the first and second supports from the first and second wall members; re-mounting the first and second supports removably and respectively in an alternate orientation on the first and second wall members; and installing a second window treatment on the first and second supports in the alternate orientation.

19. The method of claim 15 further including the step of connecting first and second bracket mounts respectively on the first and second supports; and wherein the step of mounting includes the step of mounting the first and second bracket mounts removably and respectively on the first and second wall members.

20. The method of claim 19 further including the steps of removing the first and second bracket mounts from the first and second wall members; mounting third and fourth bracket mounts removably and respectively on the first and second wall members wherein third and fourth window treatment supports are respectively connected to the third and fourth bracket mounts; and installing a second window treatment on the third and fourth supports.
